(19) United States
(12) Patent Application Publication
(10) Pub. No.: US 2023/0289151 A1
(43) Pub. Date: Sep. 14, 2023

(54) GENERATION AND CONSUMPTION OF TEMPLATES BASED ON SOURCE CODE EXAMPLES

(71) Applicant: Microsoft Technology Licensing, LLC, Redmond, WA (US)

(72) Inventors: Peter GROENEWEGEN, Sammamish, WA (US); Gustavo ARAUJO SOARES, Seattle, WA (US); Mohammad RAZA, Redmond, WA (US); Arjun RADHAKRISHNA, Seattle, WA (US)

(21) Appl. No.: 17/691,746

(22) Filed: Mar. 10, 2022

(51) Int. Cl. G06F 8/36

(52) U.S. Cl. CPC G06F 8/36

(57) ABSTRACT

Generating a template based on source code examples includes identifying a set of related files within a source code project, and identifying a set of textual content portions that are each at least partially repeated across a subset of the related files. A set of templates is generated, each comprising at least one textual content portion from the set of textual content portions. Each template is associated with a set of selection criteria. The set of templates is exposed for automated consumption within a source code editor, based on the set of selection criteria associated with each template. Consuming a template includes identifying a user input indicating creation of a source code block or file within the source code editor, identifying attribute(s) of the source code block or file, and using the attribute(s) to identify a selection criterion associated with a particular template. The particular template is automatically presented.

### BACKGROUND

When authoring computer source code, developers often write code having similar patterns. For example, within a given project, developers may frequently use similarly structured classes (e.g., similar sets of data members, similar methods such as property getters and setters), similarly structured data structures, and the like. Additionally, when using code frameworks, developers may frequently make similar patterns of instantiations and method calls. Due to use of similar code patterns within a project, developers often start a new file in the project by copying and pasting the contents of an existing file, and using the pasted content as a baseline for the new file. Additionally, some integrated development environments (IDEs), such as VISUAL STUDIO from MICROSOFT CORPORATION, include a collection of generic built-in templates and/or support the manual creation of templates. Then, when creating a new file, these IDEs enable a developer to manually select one of these built-in or manually created templates to pre-fill the new file with the template contents.

### BRIEF SUMMARY

Currently, the support for built-in and/or manually created templates within IDEs and other programming contexts is rudimentary and limited. For example, built-in templates are generic and lack customizability. Additionally, the manual creation of templates takes active effort on the part of the developer, limiting their adoption. In either case, their use takes active steps by a developer, and operate at file-level only.

At least some embodiments described herein relate to the automatic generation of templates based on source code examples. In embodiments, a template generator identifies related source code files within one or more source code projects, and generates a set of templates based on identifying portions of textual content that are similar across those related files. Additionally, in embodiments the template generator may also associate one or more variables with a template, based on which content varies between related files. In embodiments, these variables are used to automatically customize a template when it used, based on a context of a source code file or source code block to which the template is being applied. Additionally, in embodiments, the template generator also associates each template with one or more selection criteria that are usable to automatically select the template based on one or more attributes of a source code file or source code block that is being newly created within a source code editing environment.

In embodiments, the automatic generation of templates based on source code examples makes available a set of templates that are specific to a project (or set of projects) that a developer is working on. Thus, the embodiments herein automatically make available templates that are relevant to the particular context in which the developer is working, rather than being generic. Additionally, in embodiments, maintenance of templates is automatic; that is, when a project's code changes, embodiments automatically update the set of available templates based on the code changes. This means that the set of available templates evolves as the underlying source code upon which they are based evolves. In embodiments, automatically generated templates are made available a plurality of developers working on a particular source code project, so these all developers use a consistent set of templates.

At least some embodiments described herein also relate to the automatic consumption of these automatically generated templates within a source code editing environment, such as an IDE. In embodiments, a template consumer identifies one or more attributes of a source code file or source code block that is being created within the source code editing environment, and uses those attributes to automatically select a template based on the template's selection criteria. Then, the template consumer presents the selected template within the source code editing environment, while potentially customizing one or more variables in the template based on the context of the newly created source code file or source code block.

In embodiments, the automatic consumption of automatically generated templates within a source code editing environment reduces the cognitive load on a developer, since the developer no longer needs to determine which templates are available, and manually select those templates. Additionally, automatically customizing a template using variables and the context of the source code file or source code block being created further reduces cognitive load, since the developer has less to change after a template has been applied.

In some aspects, the techniques described herein relate to a methods, systems, and computer program products for generating an automatically selectable source code template based on source code examples. Embodiments include: identifying a set of related files within a source code project, the set of related files including two or more files; identifying a set of textual content portions, the set of textual content portions including one or more textual content portions, each textual content portion being at least partially repeated across a subset of files in the set of related files; creating a set of templates, the set of templates including one or more templates, each template including at least one textual content portion from the set of textual content portions; associating each template in the set of templates with a set of selection criteria, the set of selection criteria including one or more selection criterion; and exposing the set of templates for automated consumption within a source code editing environment, based on the set of selection criteria associated with each template.

In some aspects, the techniques described herein relate to a methods, systems, and computer program products for presenting an automatically source code template. Embodiments include: identifying a user input indicating creation of a source code block or a source code file within a source code editing environment; identifying one or more attributes of the source code block or source code file; based on the one or more attributes, identifying a selection criterion associated with a particular template from among a set of templates; and automatically presenting the particular template within the source code editing environment.

In some aspects, the techniques described herein relate to a methods, systems, and computer program products for generating and consumption of templates based on source code examples. Embodiments include: identifying a set of related files within a source code project, the set of related files including two or more files; identifying a set of textual content portions, the set of textual content portions including one or more textual content portions, each textual content portion being at least partially repeated across a subset of files in the set of related files; creating a set of templates, the set of templates including one or more templates, each template including at least one textual content portion from the set of textual content portions; associating each template in the set of templates with a set of selection criteria, the set of selection criteria including one or more selection criterion; exposing the set of templates for automated consumption within a source code editing environment; and based on exposing the set of templates for automated consumption within the source code editing environment: identifying a user input indicating creation of a source code block or a source code file within the source code editing environment; identifying one or more attributes of the source code block or source code file; based on the one or more attributes, identifying a selection criterion associated with a particular template from among the set of templates; and automatically presenting the particular template within the source code editing environment.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates the generation and consumption of templates based on source code examples; and

FIG. 2 illustrates an example of a template generator that generates automatically selectable source code templates based on source code examples;

FIG. 3 illustrates an example of a template consumer that presents an automatically selectable source code template within a source code editor;

FIG. 4 illustrates a flowchart of an example method for generating an automatically selectable source code template based on source code examples;

FIG. 5 illustrates a flowchart of an example method for presenting a source code template;

FIG. 6A illustrates an example of two related source code files; and

FIG. 6B illustrates an example of a template generated from the two related source code files shown in FIG. 6A.

### DETAILED DESCRIPTION

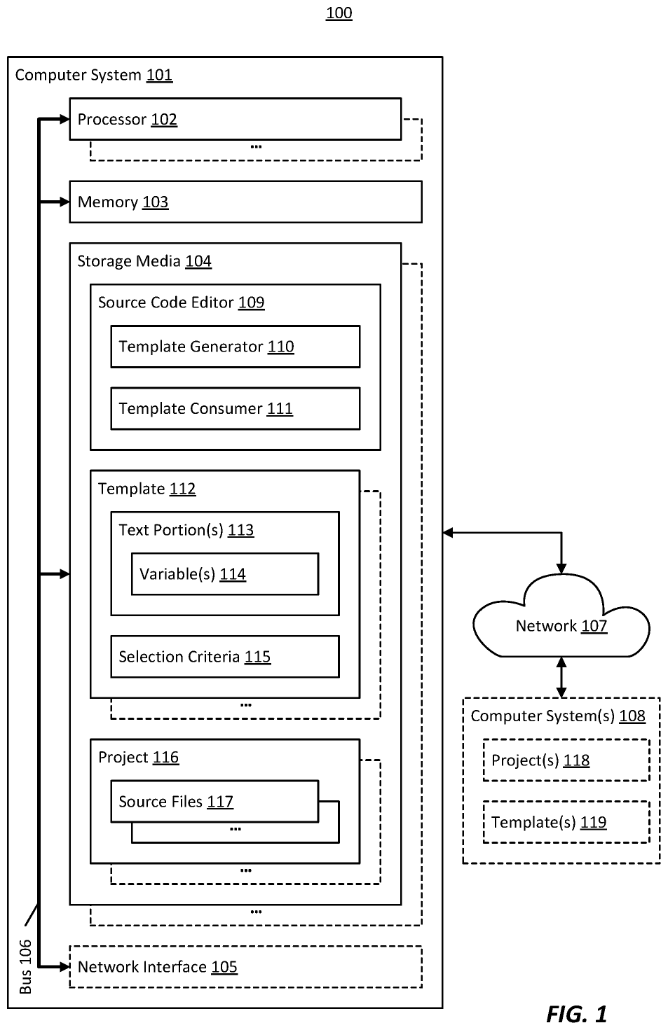

FIG. 1 illustrates an example computer architecture 100 that facilitates the generation and consumption of templates based on source code examples. As shown, computer architecture 100 includes a computer system 101 comprising a processor 102 (or a plurality of processors), a memory 103, and one or more computer storage media (storage media 104), all interconnected by a bus 106. As shown, computer system 101 may also include a network interface 105 for interconnecting (via a network 107) to one or more other computer system(s) 108.

The storage media 104 is illustrated as storing computer-executable instructions implementing at least a template generator 110 and a template consumer 111. The template generator 110 and the template consumer 111 are illustrated as being part of a source code editor 109 (e.g., an IDE), though in embodiments one or more of the template generator 110 or the template consumer 111 could be separate from the source code editor 109 (e.g., standalone applications, plug-ins).

In embodiments, the template generator 110 generates source code templates (e.g., template 112), based on source code examples obtained from one or more source code projects (e.g., project 116). For example, project 116 is shown as including a plurality of source files 117, which are used as source code examples. In embodiments, each template comprises textual content (e.g., text portion(s) 113) that is used as template text when presenting the template within the source code editor 109. In embodiments, one or more portions of this textual content is associated with one or more variables (e.g., a variable(s) 114) that indicate portion(s) of the textual content that is found to vary across the source code examples, and which are used to automatically customize the textual content when presenting the template within the source code editor 109 (e.g., based on a context within the source code editor 109), or to indicate areas that may need manual user attention. In embodiments, each template is also associated with a set of selection criteria (e.g., selection criteria 115) that is used by the template consumer 111 to automatically select the template during editing of source code files within the source code editor 109, based on a context within the source code editor 109.

While only one template (i.e., template 112) is expressly shown within the storage media 104, FIG. 1 illustrates (via broken lines and an ellipsis associated with template 112) that there could be any number of additional templates stored within storage media 104; FIG. 1 also shows that templates could be additionally, or alternatively, be stored at computer system(s) 108 (i.e., template(s) 119). Similarly, while only one source code project (i.e., project 116) is expressly shown within storage media 104, FIG. 1 illustrates (via broken lines and an ellipsis associated with project 116) that there could be any number of additional source code projects stored within storage media 104; FIG. 1 also shows that source code projects could be additionally, or alternatively, be stored at computer system(s) 108 (i.e., project(s) 118).

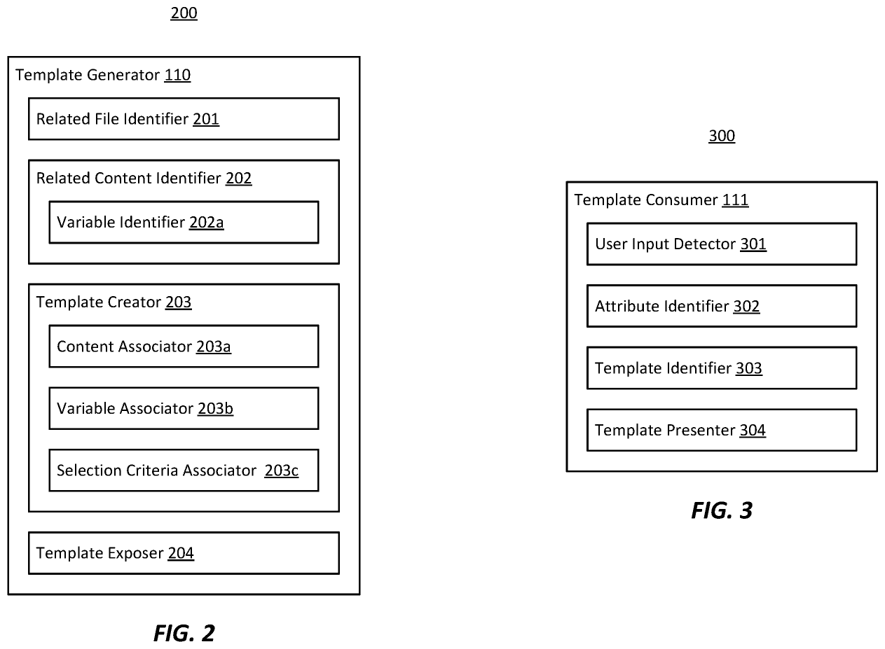

FIG. 2 illustrates an example 200 of a template generator (e.g., template generator 110) that generates automatically selectable source code templates based on source code examples. In general, the template generator 110 processes example source code (e.g., source files 117) from one or more source code projects (e.g., project 116, project(s) 118), and generates a set of one or more templates (e.g., template 112, template(s) 119) based on identifying portions of textual content that are similar across related files in a source code project (or even across related files in a plurality of source code projects). In embodiments, the template generator 110 associates information (e.g., selection criteria 115) with each template, which is usable to determine when it would be appropriate to automatically select that template in the source code editor 109.

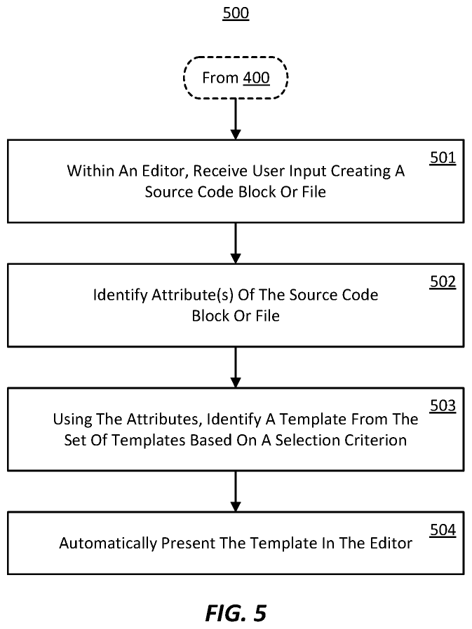

The components of the template generator 110 are now described in connection with FIG. 4, which illustrates a flow chart of an example method 400 for generating an automatically selectable source code template based on source code examples. In embodiments, instructions for implementing method 400 are encoded as computer-executable instructions (e.g., template generator 110) stored on a computer storage media (e.g., storage media 104) that are executable by a processor (e.g., processor 102) to cause a computer system (e.g., computer system 101) to perform method 400. Although the acts of method 400 may be discussed in certain orders, or may be illustrated as occurring in a particular order, no particular ordering is required unless specifically stated, or required because an act is dependent on another act being completed prior to the act being performed.

Referring to FIG. 2, the template generator 110 is illustrated as including a related file identifier 201. In embodiments, the related file identifier 201 identifies related files within a given source code project (e.g., project 116), or among source code projects. In embodiments, the related file identifier 201 identifies files are being related based on those files having the same file types (e.g., based on file extension, based on file metadata), based on those files having similar locations within a file hierarchy (e.g., similar paths), based on those files having similar file names (e.g., identical file names, partially matching file names), and the like.

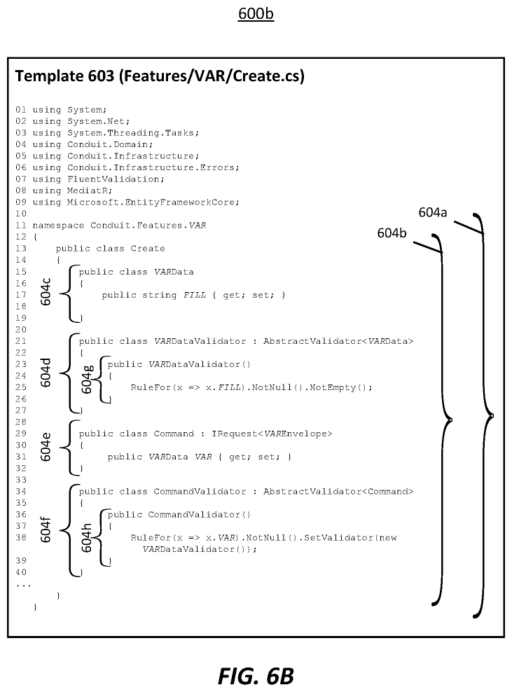

FIG. 6A illustrates an example 600a of two related source code files, including file 601 and file 602. As shown, each of file 601 and file 602 have the same file name “Create” and the same file type (e.g., extension) of “cs”. Additionally, within the hierarchy of a source code project called “Project”, file 601 has the location of “Conduit/Features/Users” while file 601 has the location of “Conduit/Features/Comments.” In embodiments, the related file identifier 201 identifies file 601 and 602 as being related based on one or more of the files having the same name (i.e., “Create”), the files having the same type (i.e., “cs”) and the files having similar hierarchical locations (i.e., “Conduit/Features/foldername”, where foldername varies between the two files).

Referring to FIG. 4, in embodiments, method 400 comprises an act 401 of identifying a set of related source code files. In some embodiments, act 401 comprises identifying a set of related files within a source code project, the set of related files comprising two or more files. In an example, the related file identifier 201 identifies two or more of source files 117 as being related, such as file 601 and file 602 shown in example 600a. In embodiments, an effect of act 401 is the identification of source code files that potentially include source code that will have repetition among the files, and which may be the basis for generation of templates that will be useful when authoring similar files in the future.

In some embodiments of act 401, identifying the set of related files comprises identifying two or more files as being related based on at least one of: the two or more files having a common file type; the two or more files having a common location within a file hierarchy; or the two or more files having at least one file name portion in common. In embodiments, an effect is to identify related files as being related because they are used in similar ways within a source code project.

Referring to FIG. 2, the template generator 110 is also illustrated as including a related content identifier 202. In embodiments, the related content identifier 202 compares the files in the set of files (e.g., file 601 and file 602) identified by the related file identifier 201, in order to determine one or more portions of textual content that repeats (or a least partially repeats) across at least a subset of those files. The manner in which the template generator 110 determines which portion(s) of textual content (at least partially) repeats across files can vary depending on implementation.

In one implementation, the related content identifier 202 determines which portion(s) of textual content (at least partially) repeats across files by converting each related file into at least one abstract syntax trees (ASTs), and then identifying one or more sub-trees that at least partially match across ASTs for different related files. In embodiments, these sub-trees correspond to portions of related content. In some embodiments, the identification of sub-trees that at least partially match across two or more ASTs involves the use of program synthesis, such as by using nodes of two or more ASTs as inputs to a program synthesis engine (e.g., PROSE from MICROSOFT CORPORATION) for the generation of regular expressions (or some other domain-specific expression) that at least partially match those nodes. In embodiments, the related content identifier 202 traverses each AST from its root node towards its leaves, looking for nodes at the same level across ASTs that have similar patterns in their content. In embodiments, once the related content identifier 202 has identified nodes at the same level across ASTs that have similar patterns in their content, the related content identifier 202 determines if those nodes have the same (or similar) leaf nodes. If so, the related content identifier 202 identifies those nodes as the roots of at least partially matching sub-trees.

In other implementations, the related content identifier 202 determines which portion(s) of textual content (at least partially) repeats across files using other forms of program synthesis, using diffing techniques (e.g., based on an edit distance algorithm, such as Levenshtein distance), using anti-unification techniques, or using machine learning techniques.

Referring to FIG. 4, in embodiments, method 400 also comprises an act 402 of identifying a set of related textual content portions. In some embodiments, act 402 comprises identifying a set of textual content portions, the set of textual content portions comprising one or more textual content portions, each textual content portion being at least partially repeated across a subset of files in the set of related files. In an example, the related content identifier 202 identifies one or more portions of textual content that is similar across the two or more source files (e.g., file 601 and file 602) identified by the related file identifier 201 in act 401. Referring to FIG. 6A, example 600a shows portions of file 601 and file 602 that are the same or similar across those files in bold.

As mentioned, in embodiments, the related content identifier 202 determines which portion(s) of textual content (at least partially) repeats across files by converting each related file into ASTs, and identifying sub-trees across those AST trees based on a root-first traversal. Thus, in some embodiments of act 402, identifying the set of textual content portions comprises generating a set of ASTs based on converting each file in the set of related files into a corresponding AST; identifying one or more sub-trees that are at least partially repeated within the set of ASTs, based at least on traversing each AST starting at a corresponding root node and identifying at least partially repeated sub-trees at corresponding AST tree levels; and converting each identified sub-tree into a textual content portion.

As mentioned, in embodiments, the related content identifier 202 could alternatively determine which portion(s) of textual content (at least partially) repeats across files using other forms of program synthesis, using diffing techniques, using anti-unification techniques, or using machine learning techniques. Thus, in some embodiments, of act 402, identifying the set of textual content portions is based on at least one of program synthesis, diffing, anti-unification, or machine learning.

Regardless of the technique(s) used, in embodiments, an effect of act 402 is to automatically identify frequently used content between related files, which is likely to be content that user(s) will use again in the future when creating similar files.

Referring to FIG. 2, the related content identifier 202 is illustrated as including a variable identifier 202a. In embodiments, the variable identifier 202a determines subset(s) of the textual content portions that vary across related files. For example, when using ASTs to identify portion(s) of textual content (at least partially) repeats across files, in embodiments the variable identifier 202a identifies differences between sub-trees (e.g., property names) as variables.

Returning to act 402, in some embodiments identifying the set of textual content portions comprises associating a variable with a particular textual content portion in the set of textual content portions, the variable corresponding to a subset of the particular textual content portion that varies across the subset of files. To illustrate, example 600a shows portions of file 601 and file 602 that are the same or similar in bold; within this bold text portions that vary are shown using italics. For instance, in example 600a, file 601 includes various uses of the string “User” (which corresponds to the foldername position of file 601's path) while file 602 includes corresponding uses of the string “Comment” (which corresponds to the foldername position of file 602's path). In embodiments, the variable identifier 202a identifies one variable where file 601 uses the string “User” while file 602 uses the string “Comment.” In embodiments, this variable is associated with foldername. Additionally, at lines 20 and 31 file 601 uses the string “Username” while at line 17 and 24 file 602 uses the string “Body”. In embodiments, the variable identifier 202a identifies another variable in connection with this varying text. In embodiments, an effect is to identify portions of content that can potentially be pre-filled (e.g., based on foldername in example 600a), or that can be flagged as needing manual user attention (e.g., in the case of the uses of “Username” by file 601 and “Body” by file 602).

Referring to FIG. 2, the template generator 110 is also illustrated as including a template creator 203. In embodiments, the template creator 203 creates one or more templates based at least on the set of related textual content portions that were identified by the related content identifier 202. Thus, for example, the template creator 203 creates template 112. As shown, the template creator 203 is illustrated as including a content associator 203a. In embodiments, for each template created, the content associator 203a associates one or more of the portion(s) of related content identified by the related content identifier 202 in act 402 with the template.

Referring to FIG. 4, in embodiments, method 400 also comprises an act 403 of creating a set of templates from the set of related textual content portions. In some embodiments, act 403 comprises creating a set of templates, the set of templates comprising one or more templates, each template comprising at least one textual content portion from the set of textual content portions. In an example, the template creator 203 creates template 112. Then, based on the portion(s) of related content identified by the related content identifier 202 in act 402, the content associator 203a associates text portion(s) 113 with that template. FIG. 6B illustrates an example 600b of a template 602 generated from file 601 and file 602 of example 600a. In example 600b, the template 602 includes textual content that was found by the related content identifier 202 to be similar between file 601 and file 602. In embodiments, an effect of act 403 is the creation of one or more templates that comprises textual content that was automatically derived from related source code files.

Referring to FIG. 2, the template creator 203 is also illustrated as including a variable associator 203b. In embodiments, the variable associator 203b associates variable(s) 114 with a template, based on the variable(s) identified by the variable identifier 202a. For example, template 603 is shown as including the variable VAR (which is associated with the foldername portion of the source file's path), and the variable FILL (which is flagged to be filled in by a user). Thus, in some embodiments of act 403, generating the set of templates comprises associating the variable with a particular template that comprises the particular textual content portion. In embodiments, an effect is to generate a template that can be automatically customized, when used, or that can indicate portion(s) that may need manual attention.

In some embodiments, the template creator 203 creates template(s) corresponding to an entire file (file-level templates). For example, template 603, taken as a whole, could be a file-level template. Additionally, or alternatively, in some embodiments the template creator 203 creates templates(s) corresponding to code blocks (block-level templates). For example, example 600b shows a few examples of block-level template that could be created, including template 604a corresponding to a namespace block, templates 604b-604f corresponding do different classes, and templates 604g and 604h corresponding to different methods. In embodiments, the template creator 203 creates both a file-level template (e.g., template 603), as well one or more overlapping block-level templates (e.g., templates 604a-604g). Thus, in some embodiments of act 604, generating the set of templates comprises generating a file-level template. Additionally, or alternatively, in some embodiments of act 604 generating the set of templates comprises generating a block-level template.

Referring to FIG. 2, the template creator 203 is also illustrated as including a selection criteria associator 203c. In embodiments, the selection criteria associator 203c associates each created template with at least one selection criterion that is usable by the template consumer 111 to select the template based on a context within the source code editor 109. In some embodiments, the selection criteria associator 203c associates a template with at least one selection criterion that is based on attributes of the files from which textual content of the template was derived, such as attributes that were used by the related file identifier 201 to identify those files as being related (e.g., file type, location within a file hierarchy, file name). Additionally, or alternatively, in some embodiments, the selection criteria associator 203c associates a template with at least one selection criterion that is based on a code block attribute corresponding to the textual content of the template, such as a loop attribute (e.g., loop type, loop parameters), a method attribute (e.g., method name, return type, method parameters), a class attribute (e.g., public/private status, class name), a data structure attribute (e.g., data structure type, data structure name), and the like.

Referring to FIG. 4, in embodiments, method 400 also comprises an act 404 of associating each template with selection criteria. In some embodiments, act 404 comprises associating each template in the set of templates with a set of selection criteria, the set of selection criteria comprising one or more selection criterion. In an example, template 603 is shown as being associated with a path (“Features/VAR”), a file name (“Create”), and a file type (“cs”). In embodiments, an effect of act 404 is to make the template(s) in the set of templates generated in act 403 automatically selectable based on the associated selection criteria.

As discussed in connection with act 403, in embodiments the template creator 203 creates a file-level template. In some embodiments of act 404, associating each template in the set of templates with the set of selection criteria includes associating the file-level template with at least one of: a first selection criterion based on file type; a second selection criterion based on file hierarchy location; or a third selection criterion based on file name. In embodiments, an effect is to make a template selectable based on an attribute (e.g., file type, hierarchical location, file name) of a file has been newly created in a source code editor.

As discussed in connection with act 403, in embodiments the template creator 203 creates a block-level template. In some embodiments of act 404, associating each template in the set of templates with the set of selection criteria includes associating the block-level template with at least one of: a first selection criterion based on a loop attribute; a second selection criterion based a method attribute; a third selection criterion based on a class attribute; or a fourth selection criterion based on a data structure attribute. In embodiments, an effect is to make a template selectable based on detecting attribute(s) of a newly created code block (e.g., attribute(s) of a loop, method, class, data structure) in a source code editor.

Referring to FIG. 2, the template generator 110 is also illustrated as including a template exposer 204. In embodiments, the template exposer 204 exposes the set of templates for consumption by the source code editor 109 at computer system 101 and/or by source code editor(s) at computer system(s) 108. For example, the template exposer 204 adds the set of templates to the templates available on storage media 104, and/or adds the set of templates to template(s) 119. In some embodiments, the template exposer 204 notifies the template consumer 111 of the availability of the new template(s).

Referring to FIG. 4, in embodiments, method 400 also comprises an act 405 of exposing the set of templates to an editor. In some embodiments, act 405 comprises exposing the set of templates for automated consumption within a source code editing environment, based on the set of selection criteria associated with each template. In embodiments, an effect of act 405 is to automatically make a new automatically selectable template (or templates) available to a local or remote source code editor.

In some embodiments of act 405, the template exposer 204 exposes the set of templates to source code editor 109 at computer system 101 (e.g., by adding the set of templates to the templates available on storage media 104). In these embodiments, exposing the set of templates for automated consumption within a source code editing environment comprises exposing the set of templates to a single-user source code editing environment. In embodiments, an effect is to make new templates available to a user (e.g., based on that user's own coding styles). Additionally, or alternatively, in some embodiments of act 405, the template exposer 204 exposes the set of templates to a source code editor computer system(s) 108 (e.g., by adding the set of templates to template(s) 119). In these embodiments, exposing the set of templates for automated consumption within a source code editing environment comprises exposing the set of templates to a multi-user source code editing environment. In embodiments, an effect is to make new templates available to plurality of users (e.g., based a developer group's coding styles).

In embodiments, method 400 repeats in order to update existing templates. In these embodiments, the template creator 203 is capable of updating existing templates, in addition to creating new templates. In embodiments, method 400 repeats based at least on the creation of a new source code file, or the updating of an existing source code file, and updates a template based on this new or updated source code file. Thus, in some embodiments, method 400 comprises updating at least one template in the set of templates based on at least one of: identifying a new file in the set of related files; or identifying an update to an existing file in the set of related files. In embodiments, an effect is to continually update the set of available templates as the corpus of available source code evolves. This keeps the set of available templates synchronized with evolving coding styles, code frameworks, and the like.

Accordingly, at least some embodiments described herein relate to the automatic generation of templates based on source code examples. For example, a template generator identifies related source code files within one or more source code projects, and generates a set of one or more templates based on identifying portions of textual content that are similar across those related files. Additionally, the template generator may also associate one or more variables with a template, based on content that varies between related files. In embodiments, these variables are used to automatically customize a template when it used, based on a context of a source code file or source code block to which the template is being applied. Additionally, the template generator also associates each template with one or more selection criteria that are usable to automatically select the template based on one or more attributes of a source code file or source code block that is being newly created. In embodiments, the automatic generation of templates based on source code examples makes available a set of templates that are specific to a project (or set of projects) that a developer is working on. Thus, the embodiments herein automatically make available templates that are relevant to the particular context in which the developer is working, rather than being generic. Additionally, in embodiments, maintenance of templates is automatic; that is, when a project's code changes, embodiments automatically update the templates changes based on the new code. This means that the set of available templates evolves as the underlying source code upon which they are based evolves. In embodiments, automatically generated templates are made available a plurality of developers working on a particular source code project, so these all developers use a consistent set of templates.

As shown, in embodiments, method 400 proceeds to method 500 (for automatically presenting an automatically selectable source code template). In some embodiments, method 400 and method 500 are each performed at computer system 101. In other embodiments, method 400 is performed at computer system 101, while method 500 is performed at one or more of computer system(s) 108.

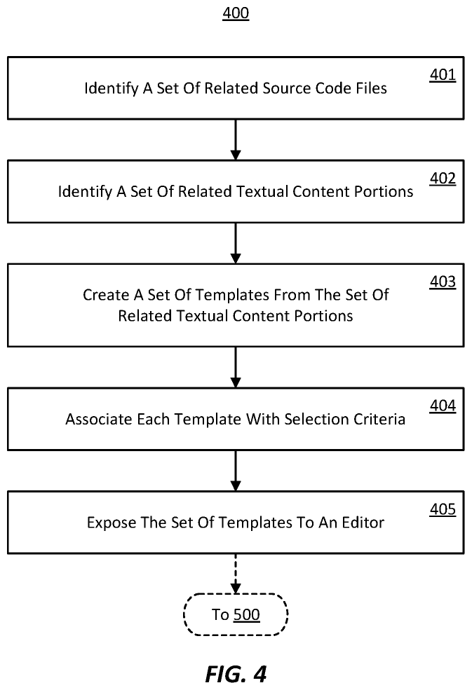

Turning to template consumption, FIG. 3 illustrates an example 300 of a template consumer (e.g., template consumer 111) that presents an automatically selectable source code template within a source code editor. In general, the template consumer 111 detects a user input event within the source code editor 109. Then, based on a context of that user input, the template consumer 111 uses the selection criteria associated with each template in a set of available templates to automatically select and present a particular template at the source code editor 109. In embodiments, a user input is associated with creation of a source code block (e.g., loop, method, class, data structure); in these embodiments, the context of the user input is attributes of the source code block (e.g., loop attribute(s), method attribute(s), class attribute(s), data structure attribute(s)). In embodiments, a user input is associated with creation of a source code file; in these embodiments, the context of the user input is attributes of the newly created source code file (e.g., file type, hierarchical location, file name).

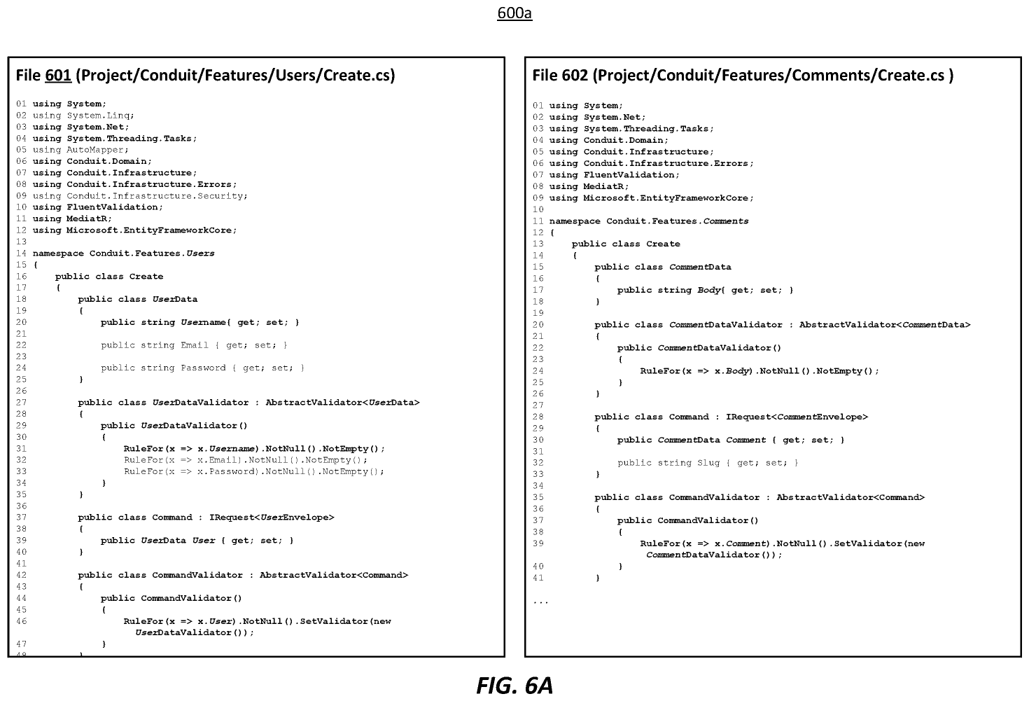

The components of the template consumer 111 are now described in connection with FIG. 5, which illustrates a flow chart of an example method 500 for presenting an automatically selectable source code template. In embodiments, instructions for implementing method 500 are encoded as computer-executable instructions (e.g., template consumer 111) stored on a computer storage media (e.g., storage media 104) that are executable by a processor (e.g., processor 102) to cause a computer system (e.g., computer system 101, computer system(s) 108) to perform method 500. Although the acts of method 500 may be discussed in certain orders, or may be illustrated as occurring in a particular order, no particular ordering is required unless specifically stated, or required because an act is dependent on another act being completed prior to the act being performed.

Referring to FIG. 3, the template consumer 111 is illustrated as including a user input detector 301. In embodiments, the user input detector 301 detects a user input, at the source code editor 109, that is associated with creation of a source code artifact. In embodiments, the source code artifact is a source code block within an existing source code file, or a new source code file. For example, a user input associated with creation of a source code block could be receipt of textual input (e.g., via a physical or touch keyboard, via voice dictation) comprising at least a portion of a loop definition, at least a portion of a method declaration, at least a portion of a class definition, at least a portion of a data structure definition, etc. A user input associated with creation of a source code block could be receipt of a menu-based command (e.g., via a pointing device, via a touch input, via voice dictation) initiating creation of a new file.

Referring to FIG. 5, in embodiments, method 500 comprises an act 501 of, within an editor, receiving user input creating a source code block or file. In some embodiments, act 501 comprises identifying a user input indicating creation of a source code block or a source code file within a source code editing environment. In an example, the user input detector 301 detects receipt of a user input at the source code editor 109 creating a source code block (e.g., via textual input) or creating a source code file (e.g., via a menu-based input). For instance, the user input is to create a new file “Create.cs” at path “Features/Groups”.

Referring to FIG. 3, the template consumer 111 is also illustrated as including an attribute identifier 302. In embodiments, the attribute identifier 302 identifies one or more attributes of the source code artifact (e.g., source code block or source code file) that is being created by the user input detected by the user input detector 301. In embodiments, when the source code artifact is a source code block, the attribute identifier 302 identifies attribute(s) of a loop that is being created (e.g., loop type, loop parameters), attribute(s) of a method that is being created (e.g., method name, return type, method parameters), attribute(s) of a class that is being created (e.g., public/private status, class name), attribute(s) of a data structure that is being created (e.g., data structure type, data structure name), etc. In embodiments, when the source code artifact is a source code file, the attribute identifier 302 identifies attributes such as a file type being created, a location of the new file within a file hierarchy, a file name assigned to the new file, etc.

Referring to FIG. 5, in embodiments, method 500 also comprises an act 502 of identifying attribute(s) of the source code block or file. In some embodiments, act 502 comprises identifying one or more attributes of the source code block or source code file. In an example, the attribute identifier 302 identifies attribute(s) of the source code block or source code file whose creation was detected in act 501. For instance, based on creation of the new file “Create.cs” at path “Features/Groups” in act 501, the attribute identifier 302 identifies a file name of “Create” a file type of “cs” and a path of “Features/Groups”. In embodiments, an effect of act 502 is to identify attributes of a newly created source code artifact, which are usable to automatically select an appropriate template to assist in the authoring of the source code artifact.

In some embodiments of act 502, identifying the one or more attributes comprises identifying at least one of: a file type of a source code file, a file hierarchy location of the source code file, or a file name of the source code file.

In some embodiments of act 502, identifying the one or more attributes comprises identifying, from the source code block, at least one of: a loop attribute, a method attribute, a class attribute, or a data structure attribute.

Referring to FIG. 3, the template consumer 111 is also illustrated as including a template identifier 303. In embodiments, the template identifier 303 uses a set of attributes identified by the attribute identifier 302 to determine an appropriate template, based on the selection criteria 115 within those templates. In embodiments, if the set of attributes identified by the attribute identifier 302 include a file type, a file hierarchy location, and/or a file name of a newly created file, the template identifier 303 may identify a template based on selection criteria that are based on file type, file hierarchy location, and/or file name. In embodiments, if the set of attributes identified by the attribute identifier 302 include a source code block attribute (e.g., loop attribute, method attribute, class attribute, data structure attribute), the template identifier 303 may identify a template based on selection criteria that are based on source code block attribute.

Referring to FIG. 5, in embodiments, method 500 also comprises an act 503 of, using the attributes, identifying a template from the set of templates based on a selection criterion. In some embodiments, act 503 comprises, based on the one or more attributes, identifying a selection criterion associated with a particular template from among a set of templates. In this example, the template identifier 303 identifies template 603 based on the new file having the same name, same type, and a similar path to the selection criteria within the template. In embodiments, an effect of act 503 is to select a template for a newly created source code attribute which is contextually relevant to that source code attribute.

In some embodiments of act 503, identifying the selection criterion associated with the particular template comprises identifying at least one of: a first selection criterion based on file type, a second selection criterion based on file hierarchy location, or a third selection criterion based on file name.

In some embodiments of act 503, identifying the selection criterion associated with the particular template comprises identifying at least one of: a first selection criterion based on the loop attribute, a second selection criterion based on the method attribute, a third selection criterion based on the class attribute, or a fourth selection criterion based on the data structure attribute.

Referring to FIG. 3, the template consumer 111 is also illustrated as including a template presenter 304. In embodiments, the template presenter 304 presents a template that was selected by the template identifier 303 at the source code editor. Referring to FIG. 5, in embodiments, method 500 also comprises an act 504 of automatically presenting the template in the editor. In some embodiments, act 504 comprises automatically presenting the particular template within the source code editing environment.

In embodiments, when the user input detector 301 has detected creation of a new source code file, presenting an automatically selected template by the template presenter 304 includes automatically filling a new source code file with contents of the selected template. In some embodiments, when filling a new source code file with contents of a template, the template contents are shown in deemphasized text, such as different color of text (e.g., gray) than a color of text (e.g., black) that a user has entered. In embodiments, this deemphasized is converted to normal text after a user has interacted with the template contents (e.g., to confirm that use of the template text is desired). In some embodiments, the template presenter 304 fills a newly created source code file. Thus, in some embodiments of act 504, automatically presenting the particular template within the source code editing environment comprises automatically filling the source code file with the particular template. In some embodiments, automatically filling the source code file with the particular template comprises presenting content of the particular template as deemphasized text. In an example, the template presenter 304 fills the new file created by the user input of act 501 with the contents of template 602.

In embodiments, when the user input detector 301 has detected creation of a new source code block, presenting an automatically selected template by the template presenter 304 includes presenting the template in association with the user input creating that source code block. In various embodiments, this presentation includes presentation of availability of the template (e.g., as part of a completions list that appears in association with the user input, or based on a visual indicator of availability of the template), or presentation of the template contents themselves (e.g., as part of deemphasized autocompletion text, or as part of a past action). In some embodiments, the template presenter 304 fills a source code block. Thus, in some embodiments of act 504, automatically presenting the particular template within the source code editing environment comprises contextually presenting the particular template in association with the user input. In some embodiments, contextually presenting the particular template in association with the user input comprises at least one of: presenting content of the particular template as deemphasized text; presenting the particular template within a completions list; presenting an indicator of availability of the particular template; or integrating content of the particular template with a paste action.

In embodiments, when the template being created includes a variable, the template presenter 304 may automatically change a value of the variable based on the attribute(s) identified by the attribute identifier 302. In some embodiments, the template presenter 304 customizes the template based on a variable. Thus, in some embodiments of act 504, automatically presenting the particular template within the source code editing environment comprises pre-filling a variable portion of the particular template based on the one or more attributes. In an example, when the template presenter 304 fills the new file created by the user input of act 501 with the contents of template 602, the template presenter 304 changes each instance of VAR to “Groups”.

In embodiments, an effect of act 503 is to present an automatically selected template, while potentially customizing that template based on editor context.

Accordingly, at least some embodiments described herein also relate to the automatic consumption of automatically generated templates within a source code editing environment, such as an IDE. For example, a template consumer identifies one or more attributes of a source code file or source code block that is being created within the IDE, and uses those attributes to automatically select a template based on the template's selection criteria. Then, the template consumer presents the selected template within the IDE, while potentially customizing one or more variables in the template based on the context of the newly created source code file or source code block. In embodiments, the automatic consumption of automatically generated templates within a source code editing environment reduces the cognitive load on a developer, since the developer no longer needs to determine which templates are available and select those templates. Additionally, automatically customizing a template using variables and the context of the source code file or source code block being created further reduces cognitive load, since the developer has less to change after a template has been applied.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system (e.g., computer system 101) that includes computer hardware, such as, for example, one or more processors (e.g., processor 102) and system memory (e.g., memory 103), as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media (e.g., storage media 104). Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 105), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method, implemented at a computer system that includes a processor, for generating an automatically selectable source code template based on source code examples, the method comprising:
identifying a set of related files within a source code project, the set of related files comprising two or more files;
identifying a set of textual content portions, the set of textual content portions comprising one or more textual content portions, each textual content portion being at least partially repeated across a subset of files in the set of related files;
creating a set of templates, the set of templates comprising one or more templates, each template comprising at least one textual content portion from the set of textual content portions;
associating each template in the set of templates with a set of selection criteria, the set of selection criteria comprising one or more selection criterion; and
exposing the set of templates for automated consumption within a source code editing environment, based on the set of selection criteria associated with each template.

2. The method of claim 1, wherein identifying the set of related files comprises identifying two or more files as being related based on at least one of:
the two or more files having a common file type;
the two or more files having a common location within a file hierarchy; or
the two or more files having at least one file name portion in common.

3. The method of claim 1, wherein identifying the set of textual content portions comprises associating a variable with a particular textual content portion in the set of textual content portions, the variable corresponding to a subset of the particular textual content portion that varies across the subset of files.

4. The method of claim 3, wherein generating the set of templates comprises associating the variable with a particular template that comprises the particular textual content portion.

5. The method of claim 1, wherein:
generating the set of templates comprises generating a file-level template; and
associating each template in the set of templates with the set of selection criteria includes associating the file-level template with at least one of:
a first selection criterion based on file type;
a second selection criterion based on file hierarchy location; or
a third selection criterion based on file name.

6. The method of claim 1, wherein:
generating the set of templates comprises generating a block-level template; and
associating each template in the set of templates with the set of selection criteria includes associating the block-level template with at least one of:
a first selection criterion based on a loop attribute;
a second selection criterion based a method attribute;
a third selection criterion based on a class attribute; or
a fourth selection criterion based on a data structure attribute.

7. The method of claim 1, wherein identifying the set of textual content portions comprises:
generating a set of ASTs (abstract syntax trees) based on converting each file in the set of related files into a corresponding AST;
identifying one or more sub-trees that are at least partially repeated within the set of ASTs, based at least on traversing each AST starting at a corresponding root node and identifying at least partially repeated sub-trees at corresponding AST tree levels; and
converting each identified sub-tree into a textual content portion.

8. The method of claim 1, wherein identifying the set of textual content portions is based on at least one of program synthesis, diffing, anti-unification, or machine learning.

9. The method of claim 1, further comprising, based on exposing the set of templates for automated consumption within the source code editing environment:
identifying a user input indicating creation of a source code block or a source code file within the source code editing environment;
identifying one or more attributes of the source code block or source code file;
based on the one or more attributes, identifying a selection criterion associated with a particular template from among the set of templates; and
automatically presenting the particular template within the source code editing environment.

10. The method of claim 9, wherein automatically presenting the particular template within the source code editing environment comprises pre-filling a variable portion of the particular template based on the one or more attributes.

11. The method of claim 9, wherein automatically presenting the particular template within the source code editing environment comprises at least one of:
presenting content of the particular template as deemphasized text;
presenting the particular template within a completions list;
presenting an indicator of availability of the particular template; or
integrating content of the particular template with a paste action.

12. The method of claim 1, further comprising updating at least one template in the set of templates based on at least one of:
identifying a new file in the set of related files; or
identifying an update to an existing file in the set of related files.

13. The method of claim 1, wherein exposing the set of templates for automated consumption within a source code editing environment comprises at least one of:
exposing the set of templates to a single-user source code editing environment; or
exposing the set of templates to a multi-user source code editing environment.

14. A method, implemented at a computer system that includes a processor, for presenting an automatically selectable source code template, the method comprising:
identifying a user input indicating creation of a source code block or a source code file within a source code editing environment;
identifying one or more attributes of the source code block or source code file;
based on the one or more attributes, identifying a selection criterion associated with a particular template from among a set of templates; and
automatically presenting the particular template within the source code editing environment.

15. The method of claim 14, wherein the user input indicates creation of a source code file, and wherein:
identifying the one or more attributes comprises identifying at least one of: a file type of a source code file, a file hierarchy location of the source code file, or a file name of the source code file;
identifying the selection criterion associated with the particular template comprises identifying at least one of: a first selection criterion based on file type, a second selection criterion based on file hierarchy location, or a third selection criterion based on file name; and
automatically presenting the particular template within the source code editing environment comprises automatically filling the source code file with the particular template.

16. The method of claim 15, wherein automatically filling the source code file with the particular template comprises presenting content of the particular template as deemphasized text.

17. The method of claim 14, wherein the user input indicates creation of a source code block, and wherein:
identifying the one or more attributes comprises identifying, from the source code block, at least one of: a loop attribute, a method attribute, a class attribute, or a data structure attribute;
identifying the selection criterion associated with the particular template comprises identifying at least one of: a first selection criterion based on the loop attribute, a second selection criterion based on the method attribute, a third selection criterion based on the class attribute, or a fourth selection criterion based on the data structure attribute; and
automatically presenting the particular template within the source code editing environment comprises contextually presenting the particular template in association with the user input.

18. The method of claim 17, wherein contextually presenting the particular template in association with the user input comprises at least one of:
presenting content of the particular template as deemphasized text;
presenting the particular template within a completions list;
presenting an indicator of availability of the particular template; or
integrating content of the particular template with a paste action.

19. The method of claim 14, wherein automatically presenting the particular template within the source code editing environment comprises pre-filling a variable portion of the particular template based on the one or more attributes.

20. A computer system, comprising:
a processor; and
a computer storage media that stores computer-executable instructions that are executable by the processor to cause the computer system to at least:
identify a set of related files within a source code project, the set of related files comprising two or more files;
identify a set of textual content portions, the set of textual content portions comprising one or more textual content portions, each textual content portion being at least partially repeated across a subset of files in the set of related files;
create a set of templates, the set of templates comprising one or more templates, each template comprising at least one textual content portion from the set of textual content portions;
associate each template in the set of templates with a set of selection criteria, the set of selection criteria comprising one or more selection criterion;
expose the set of templates for automated consumption within a source code editing environment; and
based on exposing the set of templates for automated consumption within the source code editing environment:
identify a user input indicating creation of a source code block or a source code file within the source code editing environment;
identify one or more attributes of the source code block or source code file;
based on the one or more attributes, identify a selection criterion associated with a particular template from among the set of templates; and
automatically present the particular template within the source code editing environment.
